(19) United States
(12) Patent Application Publication
(10) Pub. No.: US 2007/0265061 A1
(43) Pub. Date: Nov. 15, 2007

(54) Method of playing a slot machine game using payline sub-sets

(76) Inventors: Daniel Marks, Cold Spring, NY (US); Anthony Singer, Ramsey, NJ (US)

Correspondence Address: PTT LLC (D/B/A HIGH 5 GAMES), 1200 MACARTHUR BLVD, MAHWAH, NJ, 07430, US

(21) Appl. No.: 11/800,344

(22) Filed: May 4, 2007

Related U.S. Application Data
(60) Provisional application No. 60/798,833, filed on May 9, 2006.

(51) Int. Cl. A63F 13/00

(52) U.S. Cl. 463/20

(57) ABSTRACT

The present invention includes a variety of methods for wagering upon one or more sub-sets of payline positions and issuing awards for winning symbols appearing in the wagered upon sub-sets. A preferred embodiment allows the player to wager upon sub-sets of three or more adjacent payline positions for each of the five-position paylines (P1, P2, P3, P4, P5), starting from the leftmost position of the payline, with wagers placed upon three-position (P1, P2, P3), four-position (P1, P2, P3, P4), and five-position (P1, P2, P3, P4, P5) sub-sets.

### PRIORITY CLAIM

This application is a non-provisional patent application that claims priority to and the benefit of U.S. Provisional Patent Application Ser. No. 60/798,833, filed May 9, 2006, incorporated herein by reference.

### COPYRIGHT NOTICE

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright rights.

### FIELD OF INVENTION

In general, the present invention relates to new methods for wagering upon the paylines of a video slot machine game. More specifically, the present invention relates to wagering upon sub-sets of payline positions and issuing awards for winning symbols appearing in the wagered upon sub-sets.

### BACKGROUND OF THE INVENTION

To play a conventional slot machine, the player deposits money into the machine, sets the wager, and spins the reels. When the reels stop spinning, the player collects credits for winning symbol combinations displayed on the reels, if any, according to a predetermined pay schedule.

While the appearance of conventional slot machines may change from one theme, such as space aliens, to another, such as farm animals, the underlying methods of play—setting the wager, spinning the reels, collecting awards—remain the same from machine to machine.

The many similarities of conventional slot machines frustrate players, casinos, and manufacturers. Players tire of games using the same methods of play; casinos cannot distinguish their games offerings from other casinos; and manufacturers cannot distinguish their products from other manufacturers.

New methods of playing slot machines, therefore, are required to provide players, casinos, and manufacturers with uniquely entertaining slot machine games, including new methods of placing payline wagers and collecting payline awards, as taught by the present invention.

### SUMMARY DESCRIPTION OF THE INVENTION

The present invention includes a variety of methods for wagering upon one or more sub-sets of payline positions and issuing awards for winning symbols appearing in the wagered upon sub-sets.

A preferred embodiment allows the player to wager upon sub-sets of three or more adjacent payline positions for each of the 243 paylines defined across the 3-row by 5-column symbol matrix.

Each payline includes five positions (P1, P2, P3, P4, P5) using one symbol from each column, with the first position (P1) in the leftmost column, the second position (P2) in the second column, the third position (P3) in the third column, the fourth position (P4) in the fourth column, and the fifth position (P5) in the fifth column.

The player may place wagers of equal value upon three-position (P1, P2, P3), four-position (P1, P2, P3, P4), and then five-position (P1, P2, P3, P4, P5) sub-sets of the available paylines. Awards issue for winning symbol combinations appearing in each of the wagered upon sub-sets, including separate awards for winning symbol combinations appearing in different sub-sets of the same payline.

In a preferred embodiment, the symbol matrix is comprised of three rows and five columns containing fifteen symbol positions. Alternatively, any size symbol matrix may be utilized with any number of symbol positions. For example, a symbol matrix may be 4 rows by 7 columns with 28 symbol positions.

In a preferred embodiment, each payline is comprised of five positions (P1, P2, P3, P4, P5). Alternatively, a payline may be comprised of any number of payline positions. For example, a payline may be comprised of three positions (P1, P2, P3) or seven positions (P1, P2, P3, P4, P5, P6, P7).

In a preferred embodiment, the player only places wagers upon the three sub-sets of payline positions offered to the player. Alternatively, a player may be permitted to wager upon any of the possible sub-sets of one or more positions in the payline, as calculated by the formula: 2^{N}−1 wherein N represents the number of elements in the set. For example, a payline with five positions (P1, P2, P3, P4, P5) provides the player with 31 possible sub-sets.

In a preferred embodiment, the player wagers upon sub-sets using three, four or five payline positions. Alternatively, any number of payline positions from a payline may comprise a sub-set upon which to wager. For example, a payline with nine positions (P1, P2, P3, P4, P5, P6, P7, P8, P9) may provide two-position (P1, P2), four-position (P1, P2, P3, P4), six-position (P1, P2, P3, P4, P5, P6) and nine-position (P1, P2, P3, P4, P5, P6, P7, P8, P9) sub-sets.

In a preferred embodiment, all of the payline positions are adjacent to each other on the payline. Alternatively, any location of positions on a payline may comprise a sub-set upon which to wager. For example, a payline with five positions (P1, P2, P3, P4, P5) may provide a two-position (P1, P3) and three-position (P2, P4, P5) sub-sets using non-adjacent symbol locations.

In a preferred embodiment, the player selects sub-sets of payline positions in a predetermined order from the smallest (P1, P2, P3) to largest (P1, P2, P3, P4, P5) number of payline positions on each payline. Alternatively, the player may select sub-sets of payline positions in any order. For example, a player may select the five-position sub-set (P1, P2, P3, P4, P5) of a five-position payline, without selecting the three-position or four-position sub-set of payline positions on that payline.

In a preferred embodiment, the player selects paylines in a predetermined order from 1 to 50 with payline 1 as the 1^{st} payline selected and payline 243 as the 243^{rd} payline selected. Alternatively, the player may select paylines in any order. For example, in a game with 243 available paylines, a player may wager upon paylines 27 to 85 and 140 to 240.

In a preferred embodiment, the player must place wagers of equal value upon each of the wagered upon sub-sets of payline positions. Alternatively, the player may wager any amount upon each of the sub-sets. For example, 5-credits wager may be placed on three-position sub-sets, 15-credit wagers may be placed on four-position sub-sets, and 50-credit wagers may be placed on five-position sub-sets.

In a preferred embodiment, the player must wager upon all sub-sets of payline positions with the lowest number of payline positions before wagering upon a higher number of payline positions. Thus, a preferred embodiment requires that the player wager upon all 243 three-position sub-sets before wagering any four-position sub-sets, and then wager upon all 243 four-position sub-sets before wagering upon any five-position sub-sets. Alternatively, the player may wager upon sub-sets of payline positions in any order. For example, in a game with 243 available paylines, a wager may be placed on three-position sub-sets for paylines 35 to 70 and five-position sub-sets for paylines 65 to 243, with no wagers placed upon four-position sub-sets on any of the paylines.

In a preferred embodiment, each wager upon a sub-set of payline positions results in an award if a predetermined combination of symbols appears in each of those payline positions. Thus, a preferred embodiment issues an award for a three-position sub-set (P1, P2, P3) in which the same symbol appears in all three of the three payline positions. Alternatively, awards may issue based upon the appearance of predetermined symbols in some of the wagered upon payline positions. For example, a three-position sub-set (P1, P2, P3) will generate an award if the same symbol appears in at least two of the three payline positions (P1, P2; P1, P3; or P2, P3).

In a preferred embodiment, each award is calculated by multiplying the value of the symbols appearing in the sub-set of payline positions by the amount wagered on those positions. Thus, a preferred embodiment calculates an award for a symbol combination appearing in a three-position sub-set (P1, P2, P3) by multiplying the 10-credit award listed on the pay schedule by the 5-credits wagered on those payline positions for a total award of 50 credits. Alternatively, awards may be calculated by multiplying the value of the symbols appearing in the sub-set of payline positions and the amount wagered on the game. For example, a symbol combination appearing in a five-position sub-set (P1, P2, P3, P4, P5) worth 100-credits is multiplied by the 50-credits wagered on the game for a total award of 5000 credits.

Thus, the present invention, including a preferred and alternatives embodiments, provide new methods to place wagers upon a payline by dividing the payline into sub-sets of one or more payline positions, allowing wagers upon each sub-set, and issuing awards for symbols appearing in the wagered upon sub-sets.

### BRIEF DESCRIPTION OF THE DRAWINGS

The accompanying figures illustrate various stages of a preferred embodiment of the present invention:

FIG. 1 shows a game screen with all sub-sets of three payline positions selected.

FIG. 2 shows a game screen with all sub-sets of four payline positions selected.

FIG. 3 shows a game screen with all sub-sets of five payline positions selected.

### DESCRIPTION OF A PREFERRED EMBODIMENT

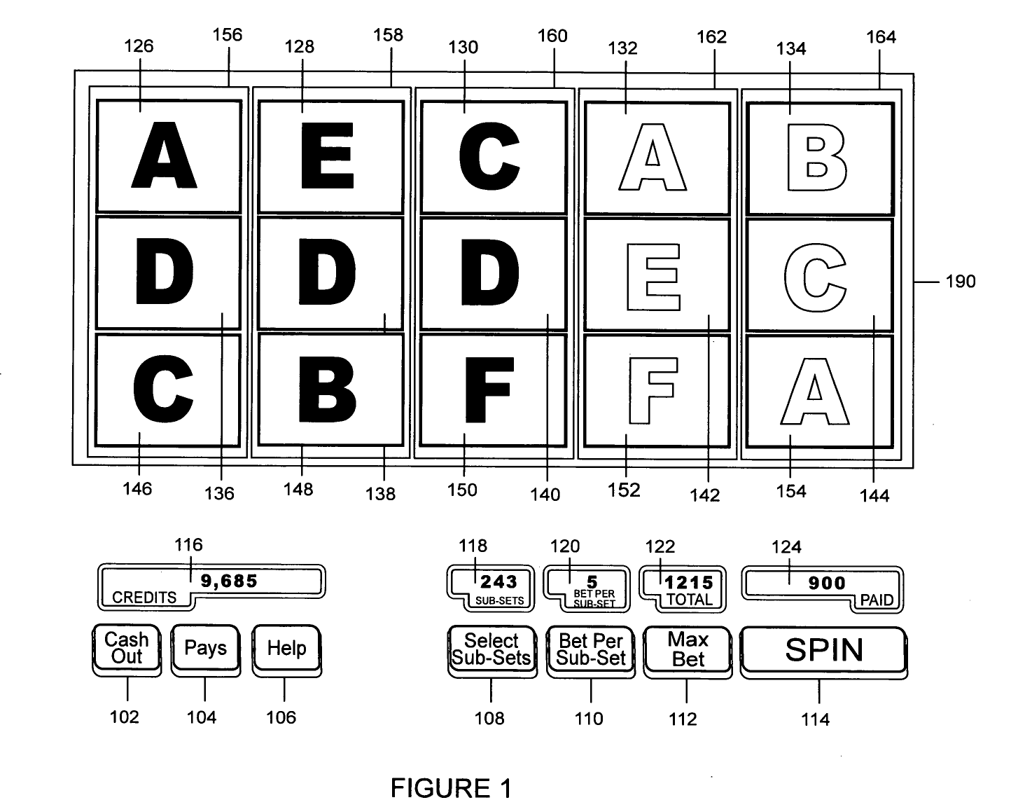

To play a preferred embodiment of the present invention, the player initializes credits, selects and wagers upon sub-sets of payline positions, spins the reels, and collects awards for winning symbol combinations appearing in the wagered upon sub-sets, as detailed below with reference to FIGS. 1 to 3:

Initialize Credits. The player initializes credits by depositing money in the form of coins, gaming tokens or paper currency into a coin head (not shown) or bill acceptor (not shown). Coins and gaming tokens are collected in a reservoir (not shown) inside the gaming machine; paper currency is collected in the bill acceptor (not shown) inside the gaming machine.

If the coins, gaming tokens or paper currency are validated as authentic, the player accrues the appropriate number of playing credits on the Credit meter 116. More credits may be initialized, if necessary, by additional deposits. Alternatively, any method of initializing credits may be used including debit cards, credit cards, smart cards, or other form of electronic funds transfer.

Available Paylines. The game defines 243 paylines (not shown) within symbol matrix 190 by selecting one symbol position in each of the five columns 156-164. Each payline includes a unique combination of five symbol positions and each payline is assigned a permanent, unique identification number between 1 and 243.

Alternatively, any number of paylines may be defined in any manner within a symbol matrix of any number of columns and/or rows, with any method of identifying each of the paylines.

Selecting Sub-Sets. The player selects sub-sets of payline positions for each payline using the Select Sub-Sets button 108. The number of selected sub-sets appears in the Sub-Sets meter 118. Alternatively, any method of selecting sub-sets of payline positions may be used, including hard-wired buttons, touch-sensitive video screen, rotating dials, audio recognition, or other systems for player-activated input.

The player may select sub-sets of the first three, four or five adjacent positions on each of the 243 available paylines, starting from the leftmost position of each payline, in a predetermined order: three-position sub-sets on paylines 1 to 243, four-position sub-sets on paylines 1 to 243, and five-position sub-sets on paylines 1 to 243.

More specifically, the first selection activates the three-position sub-set on payline 1, the second selection activates the three-position sub-set on payline 2, and so forth until all 243 three-position sub-sets are selected. The 244^{th} selection activates the four-position sub-set on payline 1, the 245th selection activates the five-position sub-set on payline 2, and so forth until all 243 four-position sub-sets are selected. The 487^{th} selection activates the five-position sub-set on payline 1, the 488^{th} selection activates the five-position sub-set on payline 2, and so forth until all 243 five-position sub-sets are selected.

Wagering on Sub-Sets. The player sets the bet on selected sub-sets of payline positions using the Bet Per Sub-Set button 110. The amount bet on the selected sub-sets of payline positions appears in the Bet Per Sub-Set meter 120. Alternatively, any method of setting the bet on selected sub-sets of payline positions may be used, including hard-wired buttons, touch-sensitive video screen, rotating dials, audio recognition, or other systems for player-activated input.

The player may set the bet from 1 to N credits on each selected sub-set of payline positions, provided that the same amount is wagered on each selected sub-set of three-positions, four-positions, or five-positions of the 243 available paylines. The wager upon each sub-set remains particular to that sub-set and is not divided amongst any other sub-sets on the same or other paylines.

The total wager for each game is calculated by multiplying the number of selected sub-sets, as shown on Sub-Sets meter 118, by the amount bet per selected sub-set, as shown on Bet Per Sub-Set meter 120. The total bet amount is displayed on the Total Bet meter 122.

Spin the Reels. The player uses the Spin button 114 to randomly rearrange the symbols displayed in the symbol matrix 190. The symbol matrix 190 contains three symbol positions for each of the five slot reels 156-164 for a total of fifteen symbol positions 126-154. Alternatively, any number of reels with any number of symbol positions may be used.

The slot reels 156-164 spin and randomly stop one reel at-a-time, from left to right, until all five reels have stopped and all fifteen symbol positions 126-154 of the symbol matrix 190 are revealed. Alternatively, any size symbol matrix may be used and any method may be used to rearrange symbols in the symbol matrix.

Awards. The player receives awards for winning symbol combinations formed by the appearance of the same symbol in each position of a wagered upon sub-sets of payline positions. For example, three A symbols appearing in a three-position sub-set would generate an A-A-A award.

In addition, a wildcard symbol may act as another symbol in the symbol set and help form winning symbol combinations of same symbol. For example, two A symbols and a wildcard acting as an A symbol appearing in a three-position sub-set would generate an A-A-A award.

A pay schedule lists the award for each winning symbol combination. Any number of winning symbol combinations may be defined, with any amount assigned to each award. For example, the pay schedule may define three “A” symbols, appearing in a three-position sub-set, as a winning symbol combination with an award of 10× the bet per line. The player may view the pay schedule by using the Pays button 104.

### Example of a Preferred Embodiment

FIGS. 1 to 3 provide illustrative examples of a preferred embodiment of the present invention, including selecting sub-sets of payline positions, placing wagers upon the selected sub-sets, and collecting awards for winning symbol combinations appearing in the selected sub-sets, as follows:

Three-Position Sub-Sets. In FIG. 1, the player has selected all 243 three-position sub-sets of payline positions on the 243 paylines, as shown in Sub-Sets meter 118. The three-position sub-sets were selected in accordance with the predetermined order of paylines, from 1 to 243. The player then wagered 5 credits on each of the 243 three-position sub-sets of payline positions, as shown in Bet Per Sub-Set meter 120.

The symbols appearing in the selected and wagered upon sub-sets of payline positions 126-130, 136-140, 146-150 are displayed in black text; symbols appearing in unselected payline positions 132-134, 142-144, 152-154 are displayed in black-outlined text. Alternatively, any method may be used to distinguish selected payline positions from unselected payline positions.

The total wager of 1215 credits was calculated by multiplying the number of selected sub-sets, 243, as shown in the Sub-Sets meter 118, by the wager placed on each of the selected sub-sets, 5, as shown in the Bet Per Sub-Set meter 120. The total amount wagered by the player is displayed in the Total Wager meter 122.

In FIG. 1, the three “D” symbols appearing in the first three payline positions across the middle row 136-140 of symbol matrix 190 form winning “D-D-D” symbol combinations on the following 9 paylines (with the three-position sub-sets in bold type): 136, 138, 140, 132, 134; 136, 138, 140, 132, 144; 136, 138, 140, 132, 154; 136, 138, 140, 142, 134; 136, 138, 140, 142, 144; 136, 138, 140, 132, 154; 136, 138, 140, 152, 134; 136, 138, 140, 152, 144; and 136, 138, 140, 152, 154. No other three-position sub-sets of payline positions contain winning symbol combinations of three “D” symbols.

Each winning “D-D-D” symbol combination generates an award according to a predetermined pay schedule (not shown), with 9 “D-D-D” awards issued for the 9 “D-D-D” winning symbol combinations. The value of each winning “D-D-D” symbol combination is calculated by multiplying the award value listed in the pay schedule (not shown) by the 5 credits wagered on each sub-set, as shown on the Bet Per Sub-Set meter 120. For example, the pay schedule award of 20 credits “D-D-D” is multiplied by 5 to generate a 100 credit award for each “D-D-D” combination, or a total award of 900 credits for all 9 “D-D-D” combinations.

Following issuance of awards, the cumulative 900 credits are added to the player's balance of credits. As long as the player has credits on the Credit meter 116, the player may continue to play the gaming machine or the player may also collect the balance of credits by pressing the Cash Out button 102. In addition, the player may press the Help button 106 to view the rules of the game.

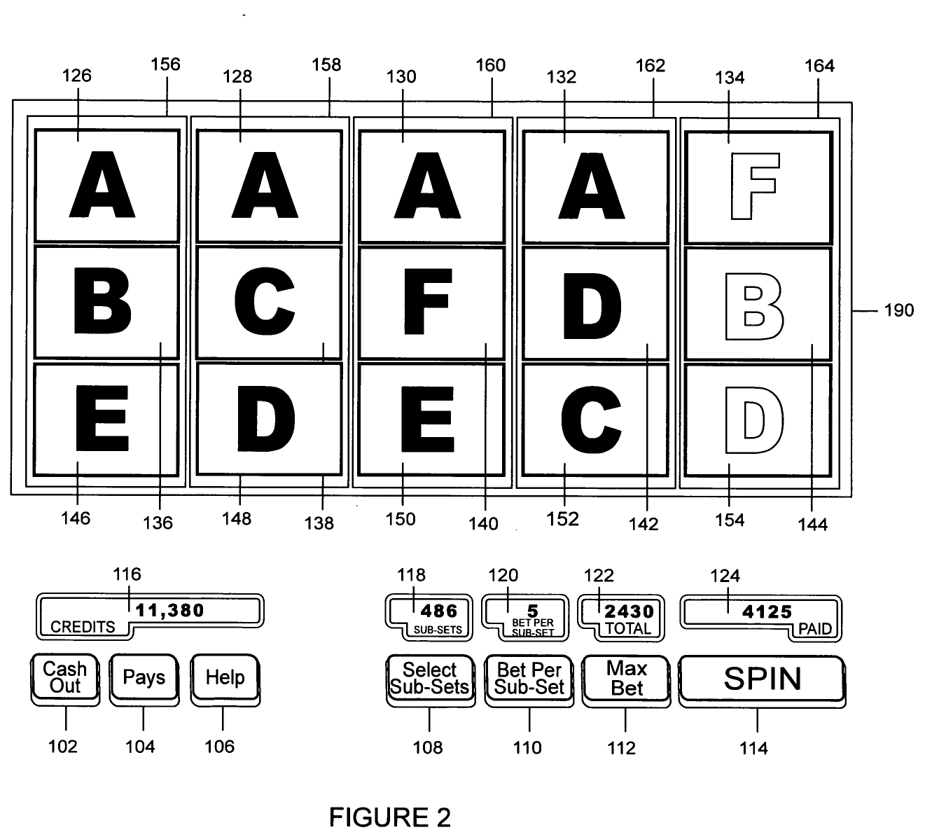

Three- and Four-Position Sub-Sets. In FIG. 2, the player has selected all 243 three-position and all 243 four-position sub-sets of payline positions on the 243 paylines, as shown in Sub-Sets meter 118. The three-position and four-position sub-sets were selected in accordance with the predetermined order of paylines, from 1 to 243, with all three-position sub-sets selected before the four-position sub-sets. The player then wagered 5 credits on each of the 486 sub-sets of payline positions, as shown in Bet Per Sub-Set meter 120.

The symbols appearing in the selected and wagered upon sub-sets of payline positions 126-132, 136-142, 146-152 are displayed in black text; symbols appearing in unselected payline positions 134, 144, 154 are displayed in black-outlined text. Alternatively, any method may be used to distinguish selected payline positions from unselected payline positions.

The total wager of 2430 credits was calculated by multiplying the number of selected sub-sets, 486, as shown in the Sub-Sets meter 118, by the wager placed on each of the selected sub-sets, 5, as shown in the Bet Per Sub-Set meter 120. The total amount wagered by the player is displayed in the Total Wager meter 122.

In FIG. 2, the “A” symbols appearing in the first four payline positions across the top row 126-132 of symbol matrix 190 form winning three-position “A-A-A” symbol combinations and winning four-position “A-A-A-A” symbol combinations:
Winning “A-A-A” symbol combinations are formed in three-position sub-sets on the following 9 paylines (with the three-position sub-sets in bold type): 126, 128, 130, 132, 134; 126, 128, 130, 132, 144; 126, 128, 130, 132, 154; 126, 128, 130, 142, 134; 126, 128, 130, 142, 144; 126, 128, 130, 132, 154; 126, 128, 130, 152, 134; 126, 128, 130, 152, 144; and 126, 128, 130, 152, 154. No other three-position sub-sets of payline positions contain winning symbol combinations of three “A” symbols.
Winning “A-A-A-A” symbol combinations are formed in four-position sub-sets on the following 3 paylines (with the four-position sub-sets in bold type): 126, 128, 130, 132, 134; 126, 128, 130, 132, 144; and 126, 128, 130, 132, 154. No other four-position sub-sets of payline positions contain winning symbol combinations of four “A” symbols. Note that four-position sub-sets do not form winning combinations of less than 4 same symbols.

The three-position and four-position winning symbol combinations generate independent awards, with the player receiving the cumulative value of all of the awards:
Each winning “A-A-A” symbol combination generates an award according to a predetermined pay schedule (not shown), with 9 “A-A-A” awards issued for the 9 “A-A-A” winning symbol combinations. The value of each winning “A-A-A” symbol combination is calculated by multiplying the award value listed in the pay schedule (not shown) by the 5 credits wagered on each sub-set, as shown on the Bet Per Sub-Set meter 120. For example, the pay schedule award of 50 credits “A-A-A” is multiplied by 5 to generate a 250 credit award for each “A-A-A” combination, or total award of 2250 credits for all 9 “A-A-A” combinations; and
Each winning “A-A-A-A” symbol combination generates an award according to a predetermined pay schedule (not shown), with 3 “A-A-A-A” awards issued for the 3 “A-A-A-A” winning symbol combinations. The value of each winning “A-A-A-A” symbol combination is calculated by multiplying the award value listed in the pay schedule (not shown) by the 5 credits wagered on each sub-set, as shown on the Bet Per Sub-Set meter 120. For example, the pay schedule award of 125 credits “A-A-A-A” is multiplied by 5 to generate a 625 credit award for each “A-A-A-A” combination, or total award of 1875 credits for all 3 “A-A-A-A” combinations.

Following issuance of awards, the cumulative 4125 credits are added to the player's balance of credits. As long as the player has credits on the Credit meter 116, the player may continue to play the gaming machine or the player may also collect the balance of credits by pressing the Cash Out button 102. In addition, the player may press the Help button 106 to view the rules of the game.

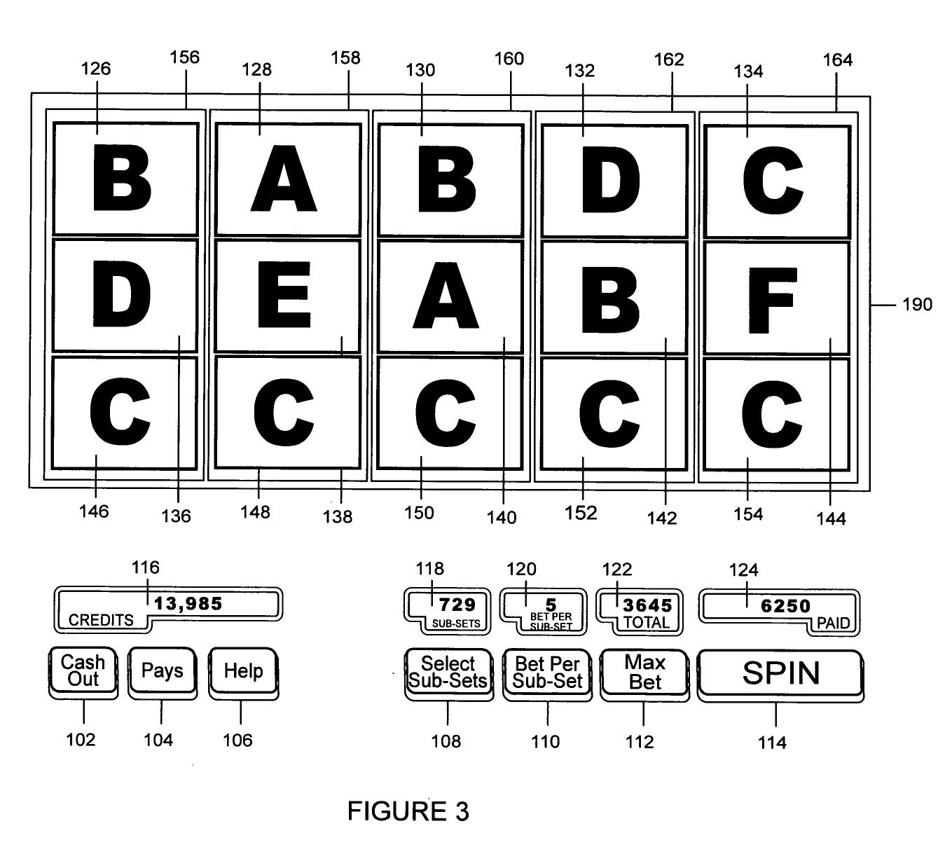

Three-, Four- and Five-Position Sub-Sets. In FIG. 3, the player has selected all 243 three-position, all 243 four-position sub-sets, and all 243 five-position sub-sets of payline positions on the 243 paylines, as shown in Sub-Sets meter 118. The three-position, four-position, and five-position sub-sets were selected in accordance with the predetermined order of paylines, from 1 to 243, with all three-position sub-sets selected before the four-position sub-sets, and all four-position sub-sets selected before the five-position sub-sets. The player then wagered 5 credits on each of the 729 sub-sets of payline positions, as shown in Bet Per Sub-Set meter 120.

The symbols appearing in the selected and wagered upon sub-sets of payline positions 126-154 are displayed in black text. By selecting all five-position sub-sets, there are no unselected payline positions. Alternatively, any method may be used to indicate the selection of payline positions in symbol matrix 190.

The total wager of 3645 credits was calculated by multiplying the number of selected sub-sets, 729, as shown in the Sub-Sets meter 118, by the wager placed on each of the selected sub-sets, 5, as shown in the Bet Per Sub-Set meter 120. The total amount wagered by the player is displayed in the Total Wager meter 122.

In FIG. 3, the “C” symbols appearing in the five payline positions across the bottom row 146-154 of symbol matrix 190 form winning three-position “C-C-C” symbol combinations, winning four-position “C-C-C-C” symbol combinations, and a winning five-position “C-C-C-C-C” combination:
Winning “C-C-C” symbol combinations are formed in three-position sub-sets on the following 9 paylines (with the three-position sub-sets in bold type): 146, 148, 150, 132, 134; 146, 148, 150, 132, 144; 146, 148, 150, 132, 154; 146, 148, 150, 142, 134; 146, 148, 150, 142, 144; 146, 148, 150, 132, 154; 146, 148, 150, 152, 134; 146, 148, 150, 152, 144; and 146, 148, 150, 152, 154. No other three-position sub-sets of payline positions contain winning symbol combinations of three “C” symbols.
Winning “C-C-C-C” symbol combinations are formed in four-position sub-sets on the following 3 paylines (with the four-position sub-sets in bold type): 146, 148, 150, 152, 134; 146, 148, 150, 152, 144; and 146, 148, 150, 152, 154. No other four-position sub-sets of payline positions contain winning symbol combinations of four “C” symbols. Note that four-position sub-sets do not form winning combinations of less than 4 same symbols.
Winning “C-C-C-C-C” symbol combination is formed in the five-position sub-set on the payline: 146, 148, 150, 152, 154. No other sub-sets of payline positions contain winning symbol combinations of five “C” symbols. Note that the five-position sub-set does not form winning combinations of less than 5 “C” symbols.

The three-position, four-position, and five-position winning symbol combinations generate independent awards, with the player receiving the cumulative value of all of the awards:
Each winning “C-C-C” symbol combination generates an award according to a predetermined pay schedule (not shown), with 9 “C-C-C” awards issued for the 9 “C-C-C” winning symbol combinations. The value of each winning “C-C-C” symbol combination is calculated by multiplying the award value listed in the pay schedule (not shown) by the 5 credits wagered on each sub-set, as shown on the Bet Per Sub-Set meter 120. For example, the pay schedule award of 30 credits “C-C-C” is multiplied by 5 to generate a 150 credit award for each “C-C-C” combination, or total award of 2250 credits for all 9 “A-A-A” combinations;
Each winning “C-C-C-C” symbol combination generates an award according to a predetermined pay schedule (not shown), with 3 “C-C-C-C” awards issued for the 3 “C-C-C-C” winning symbol combinations. The value of each winning “C-C-C-C” symbol combination is calculated by multiplying the award value listed in the pay schedule (not shown) by the 5 credits wagered on each sub-set, as shown on the Bet Per Sub-Set meter 120. For example, the pay schedule award of 100 credits “C-C-C-C” is multiplied by 5 to generate a 500 credit award for each “C-C-C-C” combination, or total award of 1500 credits for all 3 “C-C-C-C” combinations; and
The winning “C-C-C-C-C” symbol combination generates an award according to a predetermined pay schedule (not shown). The value of the winning “C-C-C-C-C” symbol combination is calculated by multiplying the award value listed in the pay schedule (not shown) by the 5 credits wagered on the sub-set, as shown on the Bet Per Sub-Set meter 120. For example, the pay schedule award of 500 credits “C-C-C-C” is multiplied by 5 to generate a 2500 credit award for the “C-C-C-C-C” combination.

Following issuance of awards, the cumulative 6250 credits are added, to the player's balance of credits. As long as the player has credits on the Credit meter 116, the player may continue to play the gaming machine or the player may also collect the balance of credits by pressing the Cash Out button 102. In addition, the player may press the Help button 106 to view the rules of the game.

### SCOPE & SPIRIT OF THE PRESENT INVENTION

The many features and advantages of the present invention are apparent from the descriptions of a preferred and alternative embodiments. The present invention, however, is not limited to these particular embodiments, as the invention is capable of being practiced and carried out in various ways. For example, new features may be added to an existing embodiment or features from two or more embodiments may be combined to produce a new embodiment. Further, features mentioned in any embodiment may be interchanged with similar features not mentioned that perform the same or similar functions. And, finally, the phraseology and terminology used to explain the embodiments are only descriptive and should not be regarded as limiting. The claims, therefore, seek to cover all features and advantages that fall within the true spirit and scope of the present invention.

We claim:

1. A method of playing a game using a symbol matrix formed by at least one row intersecting with a plurality of columns, with the rows and columns defining at least one payline and including a plurality of symbols, comprising:
a) placing a wager by:
1) selecting a sub-set of one or more payline positions from at least one payline; and
2) placing a wager on each selected sub-set of payline positions.
b) randomly rearranging the plurality of symbols;
c) displaying the rearranged symbols;
d) issuing awards based upon winning combinations of symbols appearing in each of the selected sub-sets of payline positions of the paylines.

2. A method of claim 1 in which sub-sets of payline positions are comprised of adjacent positions of a payline.

3. A method of claim 1 in which sub-sets of payline positions start from the leftmost position of a payline.

4. A method of claim 1 in which all members of the sub-set with the fewest number of payline positions must be selected before selecting members of the next sub-set with the fewest number of payline positions.

5. A method of claim 1 in which equal wagers must be placed upon all selected sub-sets of payline positions.

6. A method of claim 1 in which a winning combination is formed by the appearance of the same symbol and/or wildcard symbol in each position of a sub-set of payline positions.

7. A method of claim 1 in which the award for a winning symbol combination is calculated by multiplying the value of the winning symbol combination by the amount wagered upon the sub-set of payline positions in which the winning symbol combination appears.

8. A method of playing a game using a symbol matrix formed by at least one row intersecting with a plurality of columns, with the rows and columns defining at least one payline and including a plurality of symbols, comprising:
a) placing a wager by:
1) selecting a sub-set of two or more adjacent payline positions from at least one payline, with said adjacent positions starting from the leftmost position of said payline;
2) selecting all members of the sub-set with the fewest number of payline positions are selected before selecting members of the next sub-set with the fewest number of payline positions; and
3) placing wagers of equal value on each selected sub-set of payline positions.
b) randomly rearranging the plurality of symbols;
c) displaying the rearranged symbols; and
d) issuing awards based upon the appearance winning symbol combinations comprised of the same symbol and/or wildcard symbol in each position of a sub-set of payline positions, wherein the value of each said winning combination is calculated by multiplying the value of said winning symbol combination by the amount wagered upon the sub-set of payline positions in which said winning symbol combination appears.
